(19) United States
(12) Patent Application Publication
(10) Pub. No.: US 2013/0059661 A1
(43) Pub. Date: Mar. 7, 2013

(54) INTERACTIVE VIDEO GAME CONSOLE

(71) Applicants: Kuo-Ching Cheng, Taichung (TW); Aliex Chen, New Taipei (TW); CHIU-HAO CHENG, New Taipei (TW)

(72) Inventors: Kuo-Ching Cheng, Taichung (TW); Aliex Chen, New Taipei (TW); CHIU-HAO CHENG, New Taipei (TW)

(73) Assignee: ZEROPLUS TECHNOLOGY CO., LTD., New Taipei (TW)

(21) Appl. No.: 13/534,572

(22) Filed: Jun. 27, 2012

(30) Foreign Application Priority Data
Sep. 2, 2011 (TW) 100131706

(51) Int. Cl. A63F 13/00

(52) U.S. Cl. 463/37

(57) ABSTRACT

An interactive video game console includes a machine base, a control unit, a controller, and an image sensor. A display is provided on the machine base. The controller has a case, two light emitting devices on the case to emit predetermined light, and a motion sensor. The motion sensor is electrically connected to the control unit to sense a motion of the case and transmit it to the control unit. The image sensor senses images of the light emitting devices. The control unit controls the display to show a game image thereon, and a location of the game image on the display is determined by signals from the image sensor, a movement of the game image is determined by signals from the motion sensor.

### BACKGROUND OF THE INVENTION

1. Field of the Invention

The present invention relates generally to a video game, and more particularly to an interactive video game console.

2. Description of the Related Art

In recent days, more and more people think that entertainment is an important issue in leisure time. Entertainment may release pressure in work days and enhance the interpersonal relationship. As the improvement of video game industry, all kinds of video games, such as console game, network game and others, are popular to all ages. However, teenagers like arcade games most.

Typically, the arcade games in the present market are operated by joystick or buttons. The players do not feel reality in the game when he/she plays the game through joystick and/or buttons so that the player will feel boring after plays such games for a time. Therefore, such arcade game will be replaced by a new game in a short period.

An improved arcade game which simulates playing instrument, such as playing guitar or drum, in the game is provided to provide player a new experience. However, such game is nothing but asking the player to keep on the changing beats by beating the drum or plucking the strings. It is not a real interactive game. Therefore, there still are some places to be improved.

### SUMMARY OF THE INVENTION

The primary objective of the present invention is to provide an interactive video game console, which provides the player more reality when he/she is playing the game.

According to the objective of the present invention, an interactive video game console includes a machine base; a display provided on the machine base; a control unit provided in the machine base and electrically connected to the display; a controller having a case, at least two light emitting devices on the case to emit predetermined light, and at least a motion sensor; and an image sensor electrically connected to the control unit to sense images of the light emitting devices; A distance is kept between the light emitting devices. The motion sensor is electrically connected to the control unit to sense a motion of the case and transmit it to the control unit. The control unit controls the display to show a game image thereon; a location of the game image on the display is determined by signals from the image sensor, and a movement of the game image is determined by signals from the motion sensor.

In an embodiment, the light emitting devices are on a side of the case facing the machine base.

In an embodiment, the controller further includes a vibrator in the case and electrically connected to the control unit to be controlled by the control unit to vibrate the case.

In an embodiment, the motion sensor includes at least one of a G-sensor, a gyro, and an E-compass.

In an embodiment, the light emitting devices are infrared rays light-emitting diodes to emit infrared rays, and the image sensor has an infrared rays filter.

In an embodiment, the image sensor is a complementary metal-oxide semiconductor or a charge coupled device.

In an embodiment, the control unit controls the display to show a message when the image sensor does not sense the light emitting devices.

In an embodiment, the interactive video game console further includes an alarm device electrically connected to the control unit to generate an alarm when the image sensor does not sense the light emitting devices.

In an embodiment, vertical and transverse locations of the light emitting devices in the images sensed by the image sensor are calculated by the control unit to obtain the location of the game image on the display.

In an embodiment, a distance between the light emitting devices in images sensed by the image sensor is calculated by the control unit to obtain a size of the game image shown on the display.

In an embodiment, the light emitting devices emit flashlight with a predetermined frequency.

The player will feel that he/she really controls the game image by operating the controller when he/she is playing the game.

### BRIEF DESCRIPTION OF THE DRAWINGS

FIG. 1 is a perspective view of a preferred embodiment of the present invention;

FIG. 2 is a perspective view of the controller of the preferred embodiment of the present invention;

FIG. 3 is a sketch diagram, showing the game image moving according to the controller;

FIG. 4 shows the controller equipped with the vibrator; and

FIG. 5 shows the game console equipped with the alarm device.

### DETAILED DESCRIPTION OF THE INVENTION

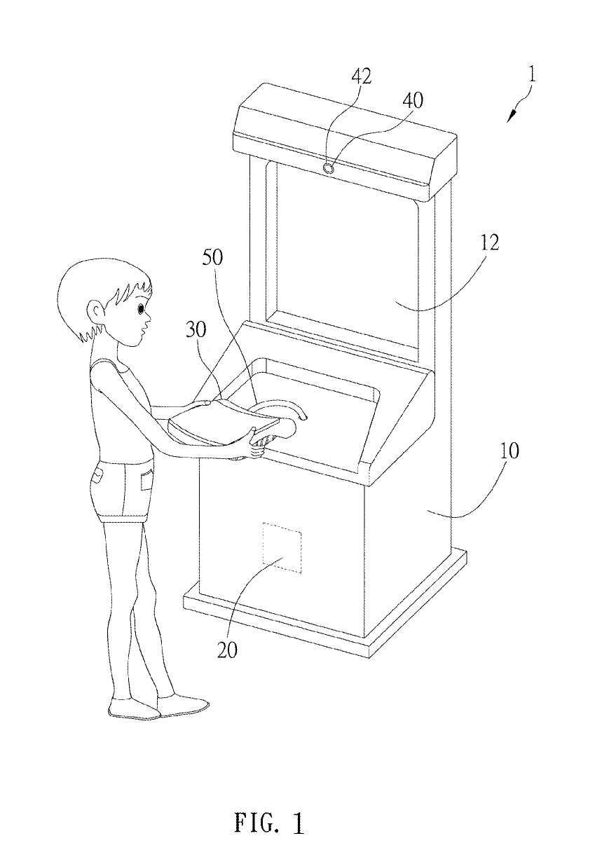

As shown in FIG. 1, an interactive video game console 1 of the preferred embodiment of the present invention includes a machine base 10, a display 12, a control unit 20, a controller 30, and an image sensor 40.

The display 12 is mounted on the machine base 10 to show images of the game.

The control unit 20 is provided in the machine base 10 and is electrically connected to the display 12. A game program is stored in the control unit 20.

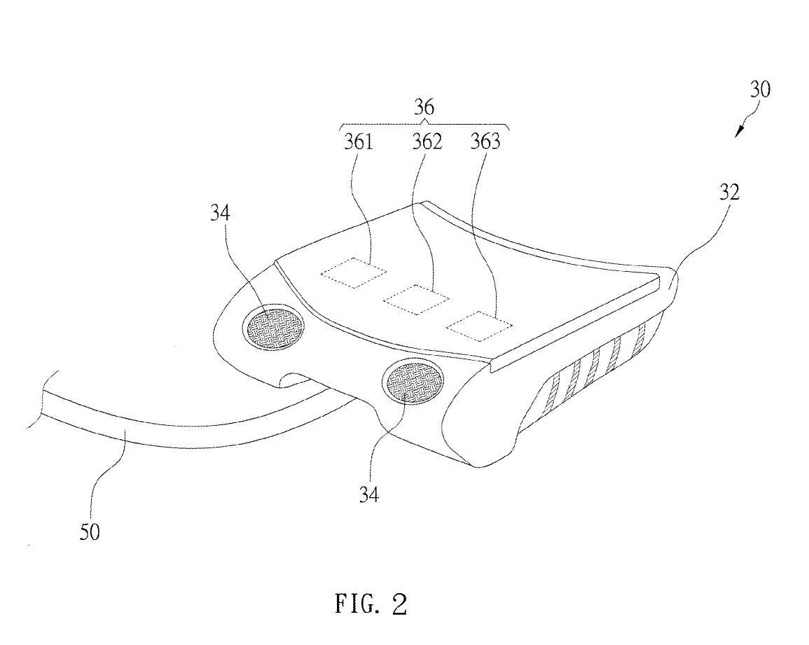

The controller 30 is connected to the machine base 10 through a cable 50, and is electrically connected to the control unit 20. As shown in FIG. 2, the controller 30 has a case 32, two light emitting devices 34, and a motion sensor 36.

The light emitting devices 34 are mounted on the case 32 at a side facing the machine base 10. A constant distance is provided between the light emitting devices 34. In the present embodiment, the light emitting devices 34 are infrared rays light-emitting diodes, and they may be replaced by any kind of suitable light emitting device, of course.

The motion sensor 36 is mounted in the case 32 and is electrically connected to the control unit 20 through the cable 50. The motion sensor 36 senses a motion of the case 32, generates according signals, and transmits it to the control unit 20. In the present embodiment, the motion sensor 36 includes a G-sensor 361, a gyro 362, and an E-compass 363. The G-sensor 361 senses an acceleration of the case 32, the gyro 362 senses an angle of inclination and an angular velocity of the case 32, and the E-compass 363 senses an orientation of the case 32.

The image sensor 40 is provided on the case 32 and is electrically connected to the control unit 20. The image sensor 40 catches image of the light emitting devices 34, and transmits it to the control unit 20. In the present embodiment, the image sensor 40 may be a complementary metal-oxide semiconductor (CMOS), a charge coupled device (CCD), or other equivalent devices. The image sensor 40 is provided with an infrared rays filter (IR filter) 42 to enhance the images of the light emitting devices 34.

The control unit 20 calculates the locations of the light emitting devices 34 through the images from the image sensor 40 to obtain a location of the controller 30 in three-dimension through vertical and transverse positions of the light emitting devices 34 and a distance between the light emitting devices 34 in the images sensed by the image sensor 40, and then shows a predetermined game image on the display 12 accordingly. The vertical and transverse positions of the light emitting devices 34 determine the location of the game image on the display, and the distance between the light emitting devices 34 indexes a distance between the controller 30 and the machine base 10 which determines a modified location and a size of the game image on the display 12. Therefore, it may create a 3-D scene on the display 12. The game image will move according to the signals from the motion sensor 36.

The light emitting devices 34 flash in a setting frequency which may help the control unit 20 to precisely identify of the case 32 in the images sensed by the image sensor 40. Any light in the images with a frequency other than the setting frequency will be taken as noises and will be filtered out. This may provide a precise detection.

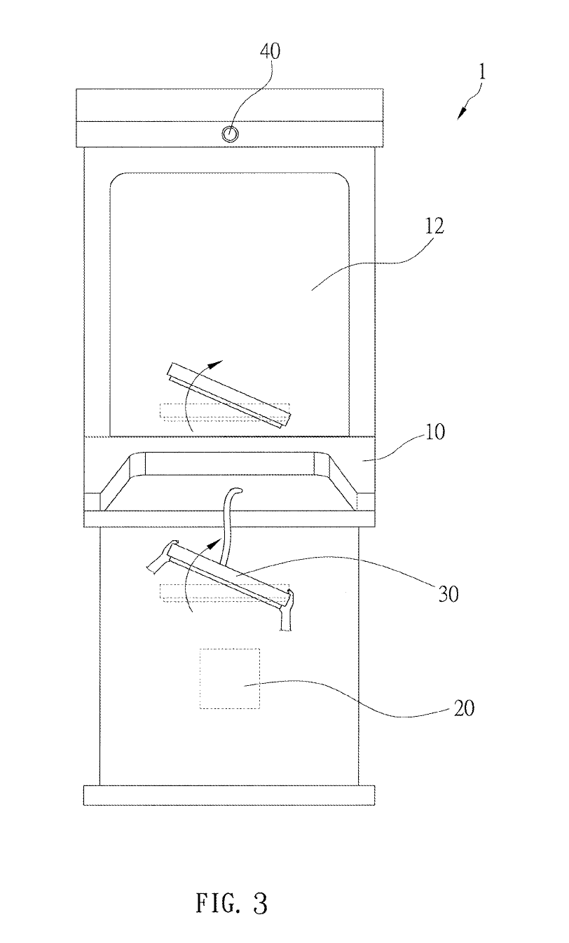

For example, as shown in FIG. 3, the game image shown on the display 12 has a shape identical to the controller 30. Any movement of the controller 30 the display will show the game image moving accordingly. It makes the player feel like he/she really controls the game image on the display 12 when he/she is playing a game by operating the controller 30.

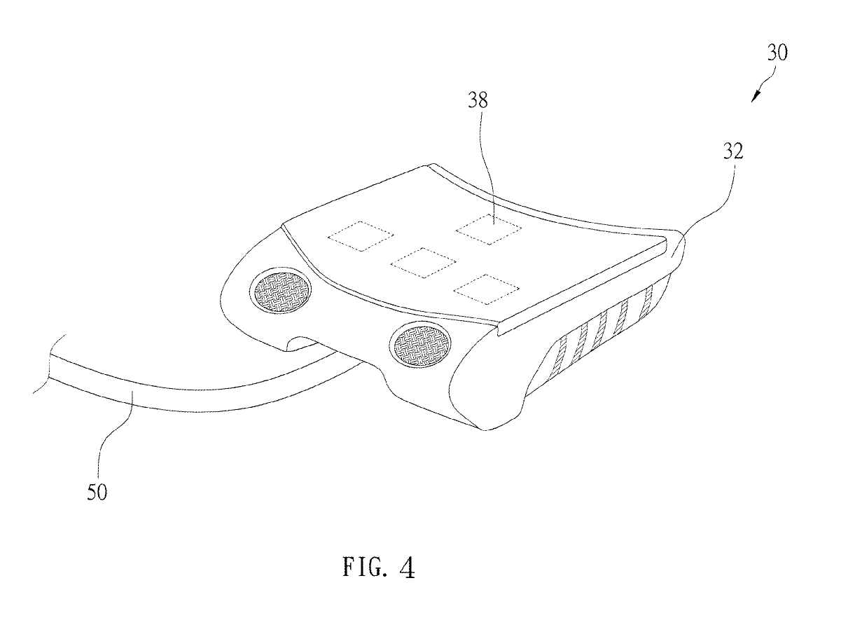

Besides, as shown in FIG. 4, the controller 30 may be provided with a vibrator 38 in the case 32. The vibrator 38 is electrically connected to the control unit 20 through the cable 50. The vibrator 38 may vibrate the case 32 when the game image on the display 12 is hit or something like that in the game. This will make the player feel like he/she was hit as same as the game image. The activation of the vibrator 38 is determined by the control unit 20, and the strength of vibration and time of duration are determined by the control unit 20 also.

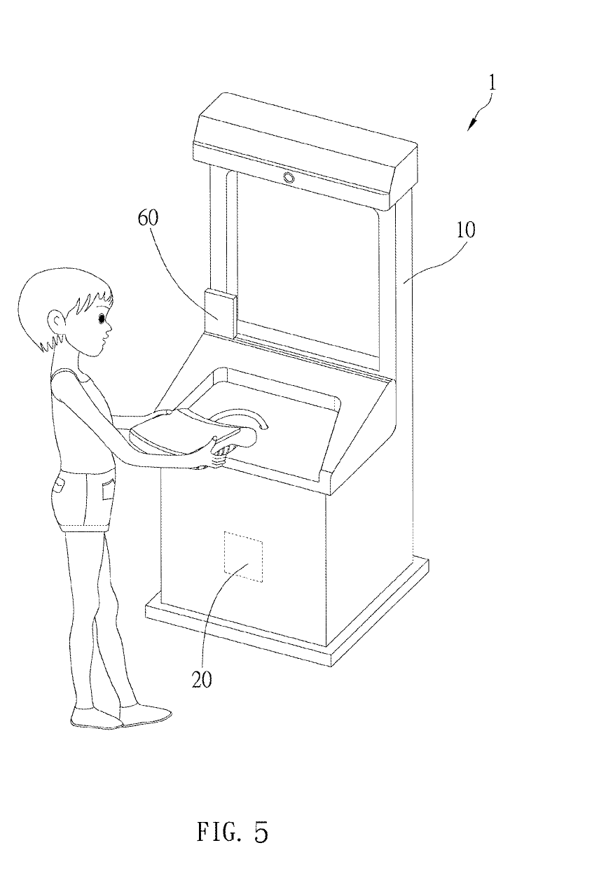

Sometime the player will leave the range of the controller 30 being sensed when he/she is playing the game. The control unit 20 will show a message on the display 12, such as “You are out of range” when the image sensor 40 does not sense the light emitting devices 34 for a time to call the player to move back. FIG. 5 shows an alarm device 50 on the machine base 10. The alarm device 50 is electrically connected to the control unit 20, and it will provide an alarm, such as flashlight or beep, to warn the player that he/she was out of the playing range when the image sensor 40 does not sense the light emitting devices 34 for a time.

The motion sensor 36 of the present invention includes the G-sensor 361, the gyro 362, and the E-compass 363. In practice, the motion sensor 36 may only has one or two of above sensing elements, or further includes other sensors.

The description above is a few preferred embodiments of the present invention and the equivalence of the present invention is still in the scope of claim construction of the present invention.

What is claimed is:

1. An interactive video game console, comprising:
a machine base;
a display provided on the machine base;
a control unit provided in the machine base and electrically connected to the display;
a controller having a case, at least two light emitting devices on the case to emit predetermined light, and at least a motion sensor, wherein a distance is kept between the light emitting devices, the motion sensor is electrically connected to the control unit to sense a motion of the case and transmit it to the control unit; and
an image sensor electrically connected to the control unit to sense images of the light emitting devices;
wherein the control unit controls the display to show a game image thereon; a location of the game image on the display is determined by signals from the image sensor, and a movement of the game image is determined by signals from the motion sensor.

2. The interactive video game console as defined in claim 1, wherein the light emitting devices are on a side of the case facing the machine base.

3. The interactive video game console as defined in claim 1, wherein the controller further includes a vibrator in the case and electrically connected to the control unit to be controlled by the control unit to vibrate the case.

4. The interactive video game console as defined in claim 1, wherein the motion sensor includes at least one of a G-sensor, a gyro, and an E-compass.

5. The interactive video game console as defined in claim 1, wherein the light emitting devices are infrared rays light-emitting diodes to emit infrared rays, and the image sensor has an infrared rays filter.

6. The interactive video game console as defined in claim 1, wherein the image sensor is a complementary metal-oxide semiconductor or a charge coupled device.

7. The interactive video game console as defined in claim 1, wherein the control unit controls the display to show a message when the image sensor does not sense the light emitting devices.

8. The interactive video game console as defined in claim 1, further comprising an alarm device electrically connected to the control unit to generate an alarm when the image sensor does not sense the light emitting devices.

9. The interactive video game console as defined in claim 1, wherein vertical and transverse locations of the light emitting devices in the images sensed by the image sensor are calculated by the control unit to obtain the location of the game image on the display.

10. The interactive video game console as defined in claim 9, wherein a distance between the light emitting devices in images sensed by the image sensor is calculated by the control unit to obtain a size of the game image shown on the display.

11. The interactive video game console as defined in claim 1, wherein the light emitting devices emit flashlight with a predetermined frequency.
